(19) United States
(12) Patent Application Publication
(10) Pub. No.: US 2016/0216597 A1
(43) Pub. Date: Jul. 28, 2016

(54) OPTICAL ACCESSORY MOUNTING DEVICE

(71) Applicant: Vorztec Pte Ltd, Singapore (SG)

(72) Inventor: Tsin Ju Lim, Singapore (SG)

(21) Appl. No.: 14/747,870

(22) Filed: Jun. 23, 2015

(30) Foreign Application Priority Data
Jan. 28, 2015 (SG) 10201500681V

(51) Int. Cl. G03B 17/56; G02B 7/14

(52) U.S. Cl. CPC G03B 17/566; G02B 7/14

(57) ABSTRACT

An optical accessory mounting device and a method of mounting an optical accessory mounting device are provided. The optical accessory mounting device comprises a first engagement member and a second engagement member, the first engagement member being movably disposed against the second engagement member; one or more urging members capable of urging the first engagement member and the second engagement member apart from each other; a stopper member disposed between the first engagement member and the second engagement member; a counter-urging member capable of urging the first engagement member and the second engagement member towards each other; and wherein the counter-urging member is disposed between the stopper member and one of the first engagement member and the second engagement member to urge the first engagement member and the second engagement member towards each other translationally.

### TECHNICAL FIELD

The present disclosure relates generally to an optical accessory mounting device and to a method of mounting an optical accessory mounting device.

### BACKGROUND

Advancements in technology have seen the development of optical accessories such as specialty lenses and filters, complementing the use of integrated cameras in mobile devices. These optical accessories, which help to capture better images, have been developed to be used with mobile devices such as personal digital assistants (PDAs), mobile phones and laptops etc. Similarly, different types of mounting devices for attaching/mounting said accessories to mobile devices have also been developed.

One form of an accessory mounting device is a “push-in” adaptor that has a fixed internal gap which corresponds to the thickness of a choice mobile device. The adaptor is pushed in a top-down direction so that it rests on an edge of said mobile device and the body of the adaptor is aligned with a camera of the mobile device. An example of such an adaptor is described in U.S. Pat. No. 8,891,187 B2.

There are a number of problems associated with such fixed gap push-in adaptors. For example, they do not take into consideration the different thicknesses of different mobile devices such as mobile phones or tablet computers. Additionally, they also do not take into consideration the use of additional screen protection films that may add to the thickness of the mobile devices. Such push-in adaptors are also limited in application, in that each adaptor can cater only to one specific mobile device with a specific thickness and that which has a camera positioned at a specific location on the mobile device.

Another problem that may arise is the irreparable scratches/damage on the surfaces of the mobile devices which can be caused by the continuous attachment and removal of said adaptor from mobile devices. Another problem that may arise is that the up-down motion of attachment and removal may also cause undesirable detachment of screen protection films on the mobile devices. Yet another problem that may arise is that a long term repeated action of attachment and removal of the adaptor from the mobile devices may cause permanent enlargement of the fixed internal gap of the push-in adaptor and subsequently, may result in loose fitting of the adaptor when mounted on the mobile devices.

Another example of a mounting device is a magnetic mounting device that works by adhering a round punched metal strip surrounding the camera of a mobile device. A magnetic material is provided on an optical accessory so that the metal strip attracts the magnetic material and attaches/mounts the optical accessory to the mobile device. An example of the above is described in U.S. Pat. No. 6,889,006 B2.

Since the above device relies on magnetic attraction for attachment, one of the problems that may arise is that the attachment itself is not secure. For example, the small surface area of the magnetic strip used to surround the camera may result in a weak magnetic force and thus a weak attraction. Hence, an accidental knock may cause the optical accessory to dislocate from the metal strip easily. In addition, the metal strip may also be easily removed from the mobile device through repeated use of force to remove the optical accessory. Another problem is that the use of adhesive such as double-sided tape at the back of the metal strip to adhere the metal strip onto the mobile device is also not desirably secure, as the adhesion strength of the adhesive may reduce and disintegrate, especially after undergoing fluctuating temperature conditions.

Yet another form of a mounting device is a rotational/pivotal-type of mounting device. Such a mounting device uses a so-called clothes-peg or clothespin mechanism. In such a mounting device, the optical accessory is mounted onto the mounting device and the device is in turn “clipped” to the mobile device via a clothes-peg mechanism. In this regard, as rotation/pivoting is needed, the mounting device requires a significant length in order to impart an appreciable rotation and attachment force to the mobile device. The length required may result in a mounting device that extends significantly beyond the edge of the mobile device. Such extension may be undesirable in appearance, and may also be easily detached due to a higher likelihood of accidental knocks to activate the clothes-peg mechanism.

Also, due to the rotational/pivotal nature of the mechanism, the mounting device may not be substantially parallel to the mobile device. The optical accessory mounted on the mounting device thus may not be substantially flushed with the camera of the mobile device, e.g. the accessory may be tilted at an angle. As such, one problem that may arise is the resultant image quality may be significantly distorted due to the misalignment of the optical accessory and the mounting device with respect to the mobile device.

Therefore, there exists a need for an optical accessory mounting device and a method of mounting an optical accessory mounting device that seek to address at least one of the problems described above.

### SUMMARY

In accordance with an aspect of the present disclosure, there is provided an optical accessory mounting device, the device comprising, a first engagement member and a second engagement member, the first engagement member being movably disposed against the second engagement member; one or more urging members capable of urging the first engagement member and the second engagement member apart from each other; a stopper member disposed between the first engagement member and the second engagement member; a counter-urging member capable of urging the first engagement member and the second engagement member towards each other; and wherein the counter-urging member is disposed between the stopper member and one of the first engagement member and the second engagement member to urge the first engagement member and the second engagement member towards each other translationally.

The device may further comprise a rod member provided within a channel extending from the first engagement member and the second engagement member, wherein the first engagement member and the second engagement member may be movable with respect to each other translationally along the rod member.

The counter-urging member may be a resilient member provided within a portion of the channel and disposed within the stopper member, wherein the resilient member may abut an internal surface of the stopper member at one end and may abut at another end said one of the first engagement member and the second engagement member.

The one or more urging members may be configured to move with respect to the first engagement member and the second engagement member to physically urge the first engagement member apart from the second engagement member.

The first engagement member and the second engagement member may be configured to form one or more housings to house the one or more urging members, wherein the one or more urging members may be provided with a decreasing surface area within the one or more housings along the direction of movement of the one or more urging members to physically urge the first engagement member apart from the second engagement member.

The one or more housings each may comprise a stop wall to limit the movement of the one or more urging members with respect to the first engagement member and the second engagement member.

The device may also further comprise one or more urging member resilient members, each provided to said one or more urging members for returning the one or more urging members to original positions after a force to urge the first engagement member apart from the second engagement member is removed.

The counter-urging member may be configured to provide a counter-urging force in a transverse direction to the direction of movement of the one or more urging members.

Said one of the first engagement member and the second engagement member may comprise an aperture.

The device may further comprise a fitment member to couple to an external connector for connecting to an optical accessory.

In accordance with another aspect of the disclosure, there is provided a method of mounting an optical accessory mounting device, the method comprising, movably disposing a first engagement member against a second engagement member; providing a stopper member disposed between the first engagement member and the second engagement member; urging the first engagement member and the second engagement member apart using one or more urging members; mounting the optical accessory mounting device over a desired position; translationally urging the first engagement member and the second engagement member towards each other using a counter-urging member, the counter-urging member being disposed between the stopper member and one of the first engagement member and the second engagement member.

The step of movably disposing a first engagement member against a second engagement member may further comprise providing a rod member within a channel extending from the first engagement member and the second engagement member; and wherein the step of urging the first engagement member and the second engagement member apart using one or more urging members and the step of translationally urging the first engagement member and the second engagement member towards each other using a counter-urging member each may comprise moving the first engagement member and the second engagement member with respect to each other translationally along the rod member.

The step of providing a counter-urging member to urge the first engagement member towards the second engagement member may further comprise providing the counter-urging member as a resilient member within a portion of the channel; disposing the resilient member within the stopper member, wherein the resilient member may abut an internal surface of the stopper member at one end and may abut at another end said one of the first engagement member and the second engagement member.

The step of urging the first engagement member apart from the second engagement member using one or more urging members may further comprise moving the one or more urging members with respect to the first engagement member and the second engagement member to physically urge the first engagement member apart from the second engagement member.

The method may further comprise providing the first engagement member and the second engagement member to form one or more housings to house the one or more urging members, wherein the one or more urging members may be provided with a decreasing surface area within the one or more housings along the direction of movement of the one or more urging members to physically urge the first engagement member apart from the second engagement member.

The method may further comprise limiting the movement of the one or more urging members with respect to the first engagement member and the second engagement member with a stop wall provided within the one or more housings.

The method may further comprise providing one or more urging member resilient members, each provided to said one or more urging members; and returning the one or more urging members to original positions after a force to physically urge the first engagement member apart from the second engagement member is removed.

The step of urging the first engagement member towards the second engagement member using a counter-urging member may comprise providing a counter-urging force in a transverse direction to the direction of movement of the one or more urging members.

The method may further comprise coupling an external connector for connecting to an optical accessory to said one of the first engagement member and the second engagement member using a fitment member.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1A is a top perspective view of an optical accessory mounting device in an example embodiment.

FIG. 1B is a perspective view of the optical accessory mounting device.

FIG. 2 is an exploded view of an optical accessory mounting device in an example embodiment.

FIG. 3A is a schematic side view of an optical accessory mounting device in an example embodiment.

FIG. 3B is an exploded view of the optical accessory mounting device.

FIGS. 4A, 4B and 4C are schematic drawings of a first engagement member of an optical accessory mounting device to illustrate movement of urging members of the optical accessory mounting device when the buttons are depressed in an example embodiment.

FIGS. 5A and B are schematic drawings of a first engagement member with side buttons and button springs of an optical accessory mounting device in an example embodiment.

FIGS. 6A and 6B are perspective view drawings of an optical accessory mounting device in an example embodiment.

FIG. 7A is a top view of an optical accessory mounting device coupled to an optical accessory component in an example embodiment.

FIG. 7B is a bottom view of the optical accessory mounting device.

FIG. 7C is a perspective view of the optical accessory mounting device.

FIG. 7D is a left view of the optical accessory mounting device.

FIG. 7E is a front view of the optical accessory mounting device.

FIG. 7F is a right view of the optical accessory mounting device.

FIG. 8A is a schematic drawing of an optical accessory mounting device for mounting to a camera provided on a rear surface of an exemplary mobile device.

FIG. 8B is a schematic drawing of an optical accessory mounting device for mounting to a camera provided on a front surface of an exemplary mobile device.

FIGS. 8C and 8D are perspective drawings of the optical accessory mounting device mounted on a mobile device with a camera provided on a rear surface.

FIG. 9 is a schematic flowchart for illustrating a method of mounting an optical accessory mounting device in an example embodiment.

### DETAILED DESCRIPTION

Exemplary, non-limiting embodiments may provide an optical accessory mounting device and a method of mounting an optical accessory mounting device on a mobile device.

In some embodiments, a mobile device may be, but is not limited to, a mobile phone, a personal device assistant (PDA), a tablet computer, a desktop computer or a laptop etc. In some embodiments, the optical accessory mounting device may be a rapid grip device/adaptor.

An optical attachment in the example embodiments may comprise two components, the optical accessory component and an optical accessory mounting device. In this regard, the optical accessory component can be mounted onto a mobile device using the optical accessory mounting device. The optical accessory mounting device in the example embodiments is configured to be removably attachable or mountable to a mobile device.

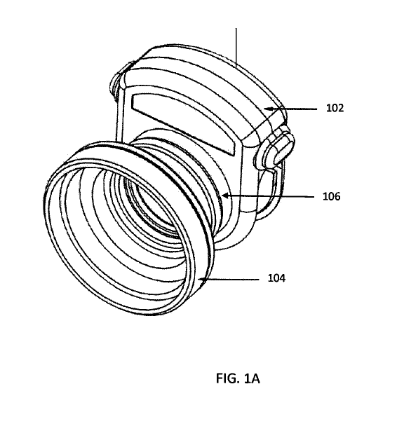

FIG. 1A is a top perspective view of an optical accessory mounting device in an example embodiment. The optical accessory mounting device 102 may be coupled to an optical accessory component 104 via an external connector 106.

The optical accessory mounting device 102 is configured to be removably attachable to a mobile device (not shown), such that the accessory component 104 e.g. a lens may be positioned in a region, in a line of sight, of an integrated camera lens in the mobile device. The alignment may enable the optical accessory component 104 to cooperate optically with the integrated camera to bring about optical alterations, modifications, enhancements etc.

FIG. 1B is a perspective view of the optical accessory mounting device 102. In FIG. 1B, the optical accessory mounting device 102 is shown without the optical accessory component 104 coupled to the optical accessory mounting device 102.

The connector 106 functions to removably couple the optical accessory component 104 to the optical accessory mounting device 102. For example, the optical accessory component 104 may be coupled to the optical accessory mounting device 102 via screw threading 108 provided with the connector 106. The connector 106 is in turn coupled to the optical accessory mounting device 102 e.g. by screw threads provided on the optical accessory mounting device 102. In some embodiments, the screw threading 108 comprises metal screw threading. In some embodiments, the screw threading is provided directly on the optical accessory mounting device 102 to couple directly to the optical accessory 104 without the external connector 106.

The optical accessory mounting device 102 of the example embodiment comprises a first engagement member 110 and a second engagement member 112 movably disposed against each other. The first engagement member 110 may be in the form of a back attachment and the second engagement member 112 may be in the form of a front attachment.

The second engagement member 112 comprises an aperture which allows light to pass through and allows a line of sight between a camera of a mobile device (not shown) and an optical accessory (for example, an optical accessory component 104 of FIG. 1A).

The optical accessory mounting device 102 also comprises two side buttons 114 and 116. The side buttons 114, 116 function as urging members to physically urge the first engagement member 110 and the second engagement member 112 apart with respect to each other. In the example embodiment, the side buttons 114, 116, when depressed, urge the first engagement member 110 and the second engagement member 112 apart to increase an internal gap distance, w, between the first engagement member 110 and the second engagement member 112. Increasing w or the engagement gap allows the optical accessory mounting device 102 to be positioned over an edge of a mobile device. When the compressive force exerted on the side buttons 114, 116 is removed, e.g. the side buttons are no longer depressed, a returning mechanism provides a perpendicular/transverse force to urge the first engagement member 110 and the second engagement member 112 to be disposed against each other, hence allowing the optical accessory mounting device 102 to be mounted onto the mobile device. The returning mechanism is provided by a counter-urging member.

The counter-urging member can urge the first engagement member and the second engagement member towards each other translationally, or in a translational manner as opposed to e.g. rotational/pivotal motion of conventional clothespin-type adaptors.

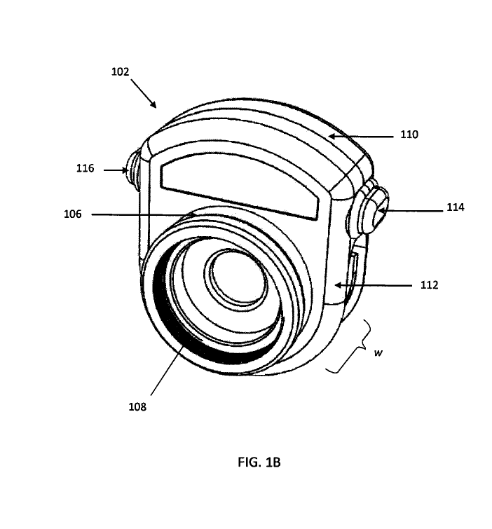

FIG. 2 is an exploded view of an optical accessory mounting device in an example embodiment.

The optical accessory mounting device 202 of the example embodiment comprises a first engagement member 204 and a second engagement member 206 movably disposed against each other.

In the example embodiment, the first engagement member 204 comprises a stopper member 208, and an extending leg portion 210. The stopper member 208 is disposed between the first engagement member 204 and the second engagement member 206. The stopper member 208 is comparatively thicker in the X-X′ direction than the extending leg portion 210.

In the example embodiment, the stopper member 208 is provided integrally with the first engagement member 204. A corresponding concave enclosure (not shown) is provided at the second engagement member 206 to accommodate the stopper member 208. In the example embodiment, the second engagement member 206 comprises an extending leg portion 214, a fitment member 216 and an aperture. The aperture is as described with respect to FIG. 1B. The fitment member 216 allows fitting of an external connector (not shown). When assembled, the first engagement member 204 and the second engagement member 206 are disposed against each other with an engagement gap formed between the extending leg portions 210, 214.

The second engagement member 206 further comprises an external aperture 218 comprising screw threads and a screw channel. Similarly, the first engagement member 204 comprises an external aperture (not shown). The stopper member 208 also comprises a holder aperture 209.

In the example embodiment, the optical accessory mounting device 202 further comprises a centre extension rod 220. The centre extension rod 220 comprises screw threads on both ends of the rod. When assembled, the centre extension rod 220 extends through a channel in the X-X′ direction from the external aperture 218 of the second engagement member 206 through the holder aperture 209 to the external aperture (not shown) provided on an external surface of the first engagement member 204. A first end of the centre extension rod 220 is secured with a washer 222 and a rod screw 224 at the external aperture (not shown) of the second engagement member 206. A second end of the centre extension rod 220 is secured with a rod screw 226 at the external aperture 218 of the second engagement member 206. Particularly, when assembled, the centre extension rod 220 is firmly secured to the second engagement member 206 via the screw connection with the rod screw 226. The first end of the centre extension rod 220 is fastened at the external aperture (not shown) of the first engagement member 204 such that there is a flexibility of translational motion for the first engagement member 204 and the second engagement member 206 along the centre extension rod 220.

In the example embodiment, the stopper member 208 comprises an internal chamber (not shown) to house a counter-urging member, for example, in the form of a resilient member 212. In the example embodiment, the resilient member 212 is in the form of a spring fitted onto or coiled around the centre extension rod 220 and may be called a rod spring. The resilient member 212 is disposed in the internal chamber (not shown) of the stopper member 208. The holder aperture 209 has a diameter smaller than the rod spring. Therefore, the resilient member 212 is disposed against an internal surface of the stopper member 208 and against one of the first and second engagement members 204, 206, in this case, the first engagement member 204. In the example embodiment, the resilient member 212 is provided within the channel between the first engagement member 204 and the holder aperture 209.

In the example embodiment, the resilient member 212 is provided in a semi-compressed lock position, whereby a first end of the resilient member 212 abuts an internal surface of the internal chamber (not shown) of the stopper member 208 and a second end of the resilient member 212 abuts against the washer 222, which is secured to the first end of the centre extension rod 220 via the rod screw 224. Therefore, without external forces applied, the resilient member 212 urges the first engagement member 204 towards the second engagement member 206.

The optical accessory mounting device 202 further comprises a first urging member 226 and a second urging member 228. In the example embodiment, the urging members 226, 228 are in the form of side buttons. In the example embodiment, each side button comprises a main body and a rod-like projection having a conical tip. For example, side button 228 comprises a main body and a rod-like projection 228a.

The optical accessory mounting device 202 may additionally comprise button resilient members 230 and 232. In the example embodiment, the button resilient members are in the form of springs, which may be referred to as button springs. In the example embodiment, each of the button springs 230 and 232 are fitted onto, or coiled around, the rod-like projection e.g. 228a of each of the side buttons 226 and 228 respectively. In the example embodiment, the side buttons 226 and 228 are disposed vertically away from the engagement gap formed between the extending leg portions 210, 214 of the first and the second engagement members 204, 206 respectively.

In the example embodiment, the optical accessory mounting device 202 further comprises housing grooves 234, 236, 238, 240. In particular, housing groove 234 is provided on a first side edge of the first engagement member 204 and housing groove 236 is provided on an opposite second side edge of the first engagement member 204. Similarly, housing groove 238 is provided on a first side edge of the second engagement member 206 and housing groove 240 is provided on an opposite second side edge of the second engagement member 206. Each of the housing grooves 234, 236, 238, 240 is contoured to house half of a side button, such that when the first and the second engagement members 204 and 206 are aligned and disposed against each other, the two resultant housing formed by the housing grooves encompass and house the side buttons 226 and 228. For example, the resultant contour or housing from housing grooves 234, 238 encompasses and houses the side button 226. Similarly, the resultant contour or housing from housing grooves 236, 240 encompasses and houses the side button 228.

In the example embodiment, the extending leg portion 210 may optionally comprise a padding 242, as an engagement surface to a mobile device. The padding 242 functions to provide a relatively soft surface to prevent or minimize damage/scratches on a mobile device as well as to provide relatively better grip on the mobile device. For example, the padding 242 may be made from, but not limited to, foam or silicon.

The operation or usage of the optical accessory mounting device 202 will now be described.

In use, the rod spring 212 is provided in a semi-compressed lock position in the internal chamber of the stopper member 208. The spring 212 abuts an internal surface of the stopper member 208 at one end, and abuts the washer 222 at the other end. The semi-compressed lock position of the rod spring 212 exerts an urging force which urges the first engagement member 204 against the second engagement member 206.

When a compressive force is exerted on the side buttons 226, 228, e.g. a user depresses the side buttons toward each other, the respective button springs 230, 232 are compressed. Depressing the side buttons causes the rod-like projections of the side buttons to slide out of the housing grooves towards the centre of the first engagement member 204 and the second engagement member 206. Due to the increasing width or surface area of the rod-like projections, the motion of the side buttons 230, 232 physically urges the first engagement member 204 and the second engagement member 206 apart relative to each other. The first engagement member 204 and the second engagement member 206 move apart relative to each other along the channel extending from the first engagement member and the second engagement member, translationally along the centre extension rod 220. The physically urging apart may also be explained by a decreasing surface area provided by the housing grooves faced by the side buttons 230, 232 towards the centre of the first engagement member 204 and the second engagement member 206.

Thus, the engagement gap between the extending leg portions 210, 214 of the first and second engagement members 204, 206 respectively is increased. As the engagement gap is increased in distance, the optical accessory mounting device 202 may then be positioned over an edge of a mobile device.

The urging apart of the second engagement member 206 from the first engagement member 204 exerts a further compressive force on the rod spring 212 due to the relative movement of the stopper member 208 along the channel and the centre extension rod 220 in the X-X′ direction. Thus, the rod spring 212 exerts a counter-urging force against the urging force by the side buttons 230, 232.

Upon attachment/mounting onto the mobile device, a removal of the initial compressive force, e.g. the user releases the side buttons 226, 228, allows the compressed button springs 230, 232 to revert the side buttons 226, 228 to their original states. The button springs 230, 232 provide a returning mechanism which pushes the side buttons 226, 228 back to their original positions. Accordingly, the rod-like projections of the side buttons 226, 228 also move back into the housing grooves and thus, the urging force to urge the first and second engagement members 204, 206 apart is removed.

The removal of the urging force at the side buttons 226, 228 results in the compressed rod spring 212 to re-extend or return to the semi-compressed state. The counter-urging force thus causes a relative translational movement of the stopper member 208 along the channel and the centre extension rod 220 towards the second engagement member 206. The urging of the first and second engagement members 204, 206 towards each other in a translational manner decreases the distance of the engagement gap between the extending leg portions 210, 214 of the first and second engagement members 204, 206 respectively. Accordingly, each extending leg portion engages a respective surface of the mobile device.

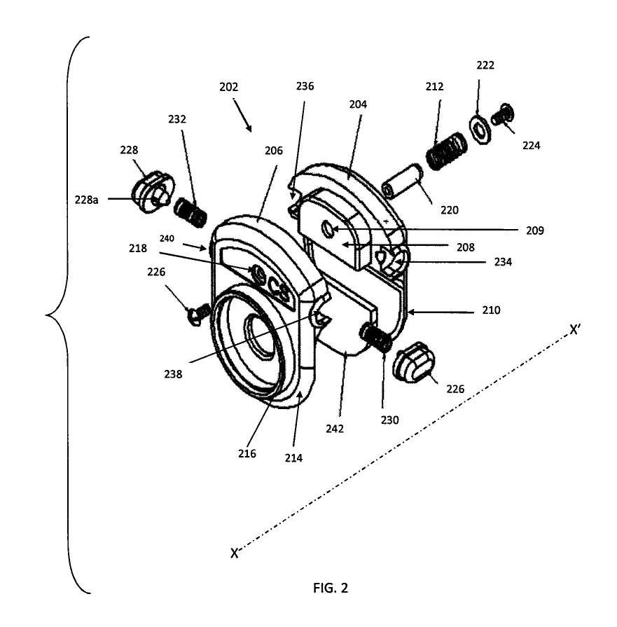

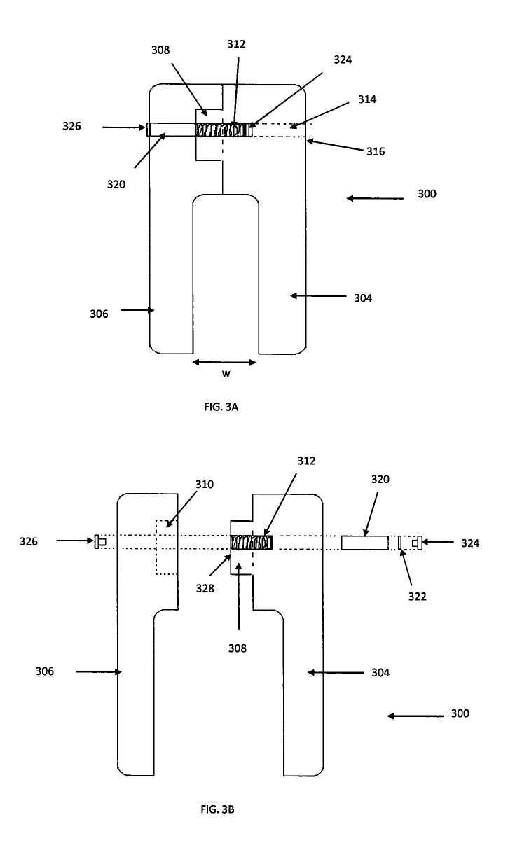

FIG. 3A is a schematic side view of an optical accessory mounting device in an example embodiment. FIG. 3B is an exploded view of the optical accessory mounting device.

The optical accessory mounting device 300 functions substantially identically to the optical accessory mounting device 202. For ease of illustration, the urging members are not shown. An example of the counter-urging member is provided below.

In the example embodiment, the optical accessory mounting device 300 comprises the stopper member 308 provided integrally with the first engagement member 304. A corresponding concave enclosure 310 is provided at the second engagement member 306 to accommodate the stopper member 308. The centre extension rod 320 extends through the channel shown in dotted profile from the external aperture receiving the rod screw 326 of the second engagement member 206 through the holder aperture of the stopper member 308 to the external aperture receiving the rod screw 324 of the first engagement member 304. The centre extension rod 220 is secured to the second engagement member 306 via the screw connection with the rod screw 326. The centre extension rod 220 is fastened at the external aperture of the first engagement member 304 with the rod screw 324 and washer 322.

A depth 314 is provided from the external surface 316 of the first engagement member 304. The depth 314 is shown in exaggerated fashion in FIG. 3A and is provided such that there is a flexibility of translational motion for the first engagement member 304 and the second engagement member 306. That is, the washer 322 and rod screw 324 may move within the depth 314 when the first engagement member 304 and the second engagement member 306 are urged apart.

In the example embodiment, the stopper member 308 comprises an internal chamber whereby the rod spring 312 is shown disposed within. The rod spring 312 is fitted onto or coiled around the centre extension rod 320. The holder aperture of the stopper member 308 has a diameter smaller than the rod spring 312. Therefore, the rod spring 312 is disposed against an internal surface 328 of the stopper member 308 and against the first engagement member 304 (via the washer 322 and rod screw 324). In the example embodiment, the rod spring 312 is provided within the channel between the first engagement member 304 and the holder aperture of the stopper member 308.

As shown in FIG. 3A, without external forces applied, the rod spring 312 urges the first engagement member 304 towards the second engagement member 306 in a translational manner. The engagement gap is shown.

In the example embodiment, when the urging members urge the first engagement member 304 and the second engagement member 306 apart, the stopper member 308 moves translationally along the centre extension rod 320 and further compresses the rod spring 312 against the first engagement member 304. Due to the channel shown in dotted profile, the extending leg portions of the first engagement member 304 and the second engagement member 306 move apart while maintained in substantially parallel relationship. When the urging force to urge the first engagement member 304 and the second engagement member 306 apart is removed, the rod spring 312 provides a counter-urging force to urge the first engagement member 304 towards the second engagement member 306 in a translational manner. In the example embodiment, the counter-urging force is applied against the internal surface 328 of the stopper member 308 such that the stopper member 308 moves translationally along the centre extension rod 320. The extending leg portions of the first engagement member 304 and the second engagement member 306 move towards each other while maintained in substantially parallel relationship.

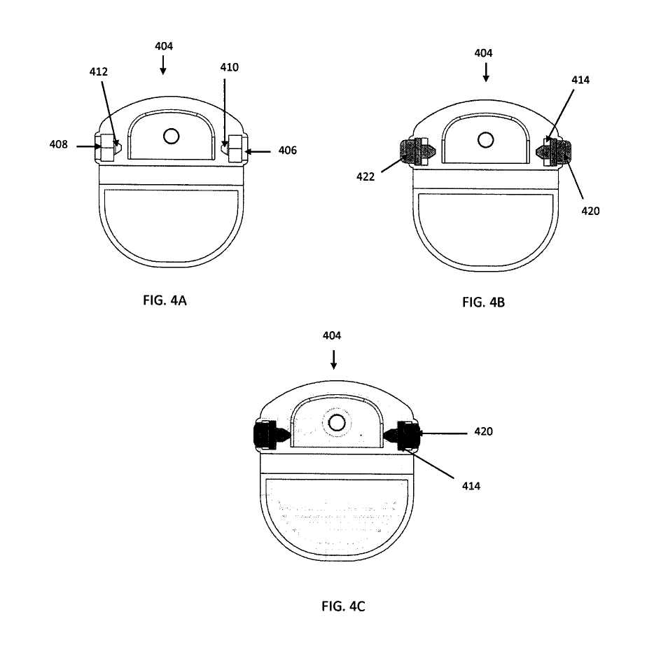

FIGS. 4A to C are schematic drawings of a first engagement member of an optical accessory mounting device to illustrate movement of urging members of the optical accessory mounting device when the buttons are depressed in an example embodiment.

FIG. 4A is a front view of the first engagement member without any urging members and with housing grooves shown. FIG. 4B is a front view of the first engagement member together with urging members. FIG. 4C is a front view of the first engagement member together with the urging members in a depressed position.

In the example embodiment, the first engagement member 404 comprises housing grooves 406 and 408. Each housing groove 406 and 408 is contoured to house an urging member such as side buttons 420 and 422. In particular, the depth of the housing groove is such that when a side button rests in it, half of the side button protrudes out of the surface plane (i.e. plane of the paper) of the first engagement member 404. The protruding part of the side button may be consequently housed in a corresponding housing groove of a second engagement member (not shown). In the example embodiment, each of the housing grooves further comprises a contoured slope 410 and 412 respectively. The slopes 410 and 412 are contoured to slant at an angle, to cater to the cone-like pointed tip of the rod-like projection of the side button. The slopes 410, 412 provide a decreasing surface area toward the centre of the first engagement member 404. As shown in FIG. 4B, the conical tip of the rod-like projection of the side button 420 rests in the slope 410. In the example embodiment, the housing groove 406 is further contoured to comprise a stop wall 414. As shown in FIG. 4C, the stop wall 414 engages with a surface of the main body of the side button 420 when the side button 420 is in the depressed position.

In use, depressing the side buttons exerts a force which causes the rod-like projection of each side button to slide up the slopes 410, 412, due to the cone-shape tip of the rod-like projection and the decreasing surface area faced by each side button. The rod-like projection of the side button slides out and gets lifted out of the groove and this in turns physically urges the first engagement member 404 and the second engagement member (not shown) apart due to the increasing width or surface area of the rod-like projection against the decreasing surface area of the slopes 410, 412. For example, the rod-like projection of side button 420 is pushed beyond the groove 410, until the main body of the side button is in contact with the side wall 414 in the groove 406.

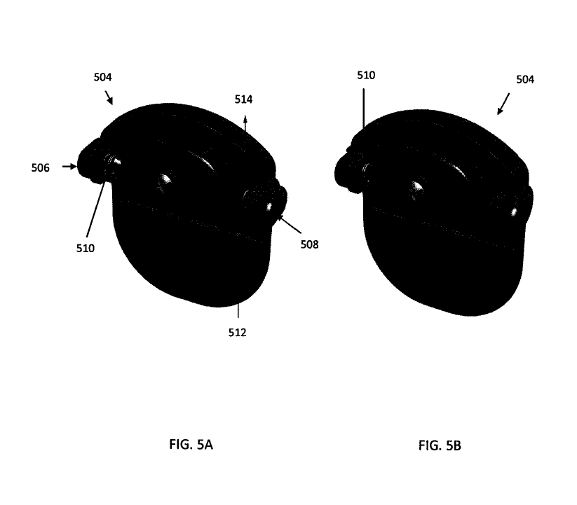

FIGS. 5A and B are schematic drawings of a first engagement member with side buttons and button springs of an optical accessory mounting device in an example embodiment.

FIG. 5A shows the side buttons and button springs in the housing groove in their original state, i.e. undepressed positions.

FIG. 5B shows the side buttons and button springs in the housing groove in depressed positions.

The first engagement member 504 functions substantially similarly to the first engagement member 404 as described with respect to FIGS. 4A to 4C, with the addition of button springs e.g. 510. For example, the button spring 510 is coiled around the rod-like projection of the side button 506.

In use, depressing the side buttons 506, 508 exerts a force which causes the rod-like projection of each side button to slide up the slopes e.g. 512 in the housing grooves. The exerted force also compresses the button springs coiled around the rod-like projections of the side buttons against the stop walls of the housing grooves. In the example embodiment, when the side button 506 is depressed, the side button 506 is pushed out of the housing groove and moves onto the surface 514 of the first engagement member 504. The button spring 510 is compressed as shown in FIG. 5B. Upon release of the side buttons, the compressed button springs re-extend and push the side buttons back to their original positions in the housing grooves.

FIGS. 6A and 6B are perspective view drawings of an optical accessory mounting device in an example embodiment. The optical accessory mounting device functions substantially identically to the optical accessory mounting device 202.

FIG. 6A shows the side buttons at their original undepressed positions and FIG. 6B shows the side buttons at depressed positions.

In the example embodiment, the rod spring 606 coils around the centre extension rod 604. The rod spring 606 is housed in the internal chamber of the stopper member in a semi-compressed state (see FIG. 6A). The rod spring 606 abuts an internal surface of the stopper member and a surface at an external aperture of the first engagement member 612. In use, the force exerted in depressing the side buttons (in the A-A′ direction) urges the first engagement member 612 away from the second engagement member 614, in a perpendicular or transverse direction (in the B-B′ direction) to the exerted force. When the second engagement member 614 is urged apart from the first engagement member 612, the movement of the second engagement member 614 moves the stopper member translationally and further compresses the rod spring 604. As shown in FIG. 6B, the rod spring 604 is compressed further in the stopper member upon depression of the side buttons to provide a counter-urging force in the B-B′ direction. The counter-urging force urges the first engagement member 612 and the second engagement member 614 translationally towards each other in a transverse direction to the urging force along the A-A′ direction.

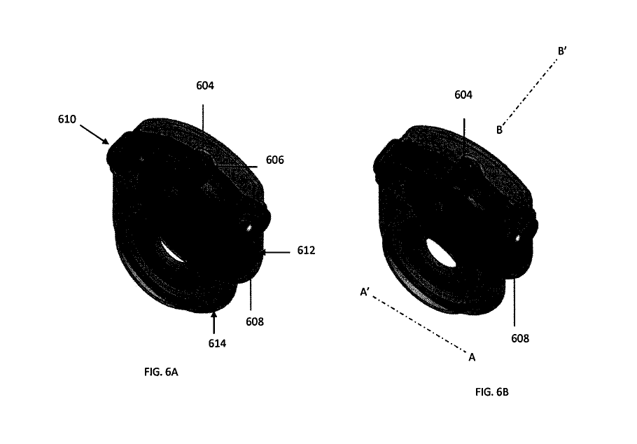

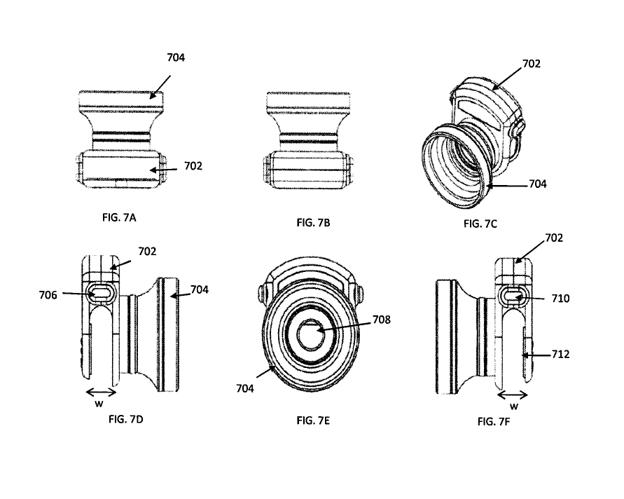

FIGS. 7A to F are drawings showing different views of an optical accessory mounting device coupled to an optical accessory component in an example embodiment.

FIG. 7A is a top view of the optical accessory mounting device 702 coupled to the optical accessory component 704.

FIG. 7B is a bottom view of the optical accessory mounting device 702.

FIG. 7C is a perspective view of the optical accessory mounting device 702.

FIG. 7D is a left view of the optical accessory mounting device 702. The side button 706 is shown disposed vertically away from the engagement gap, w. The side button 706 is shown in its original or undepressed position. The side button 706 is housed within a resultant groove formed by the first engagement member and the second engagement member.

FIG. 7E is a front view of the optical accessory mounting device 702. A line of sight 708 is through the front of the optical accessory component 704.

FIG. 7F is a right view of the optical accessory mounting device 702. The side button 710 is disposed substantially identically to the side button 706. Further, a padding 712 is provided as an engagement surface.

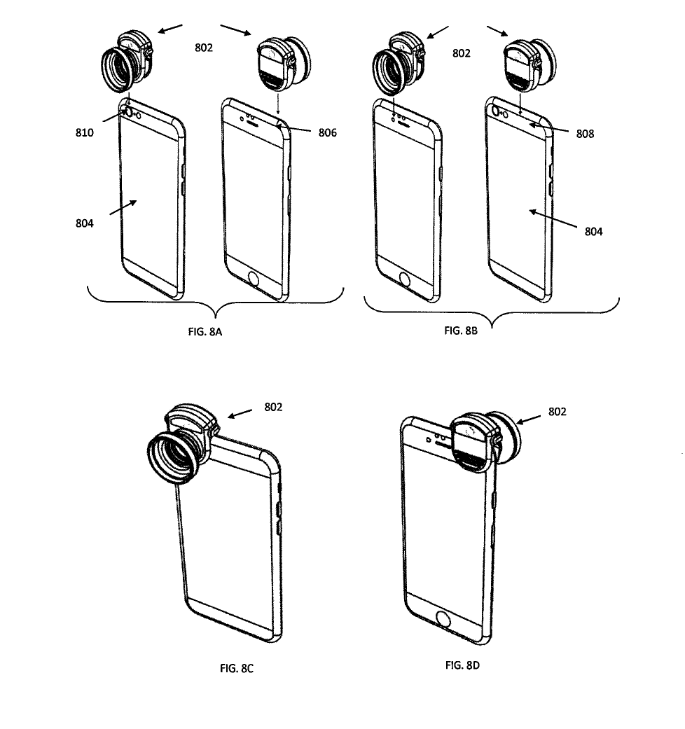

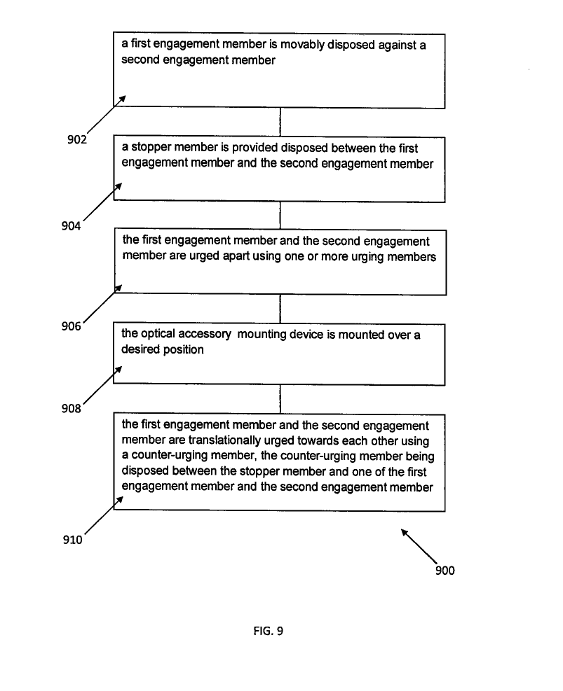

FIG. 8A is a schematic drawing of an optical accessory mounting device for mounting to a camera provided on a rear surface of an exemplary mobile device.

FIG. 8B is a schematic drawing of an optical accessory mounting device for mounting to a camera provided on a front surface of an exemplary mobile device. The rear surface is shown as numeral 808.

FIGS. 8C and 8D are perspective drawings of the optical accessory mounting device (attached with an optical accessory component such as a lens) mounted on a mobile device with a camera provided on a rear surface of the mobile device.

In FIG. 8A, the optical accessory mounting device 802 is mounted over the camera 810 provided on a rear surface of the mobile device 804. The optical accessory mounting device 802 is mounted onto the mobile device 804 over a top edge 806 of the mobile device 804. The attachment is by depressing the side buttons of the optical accessory mounting device 802. Depressing both side buttons increases the engagement gap in between the first and second engagement members of the optical accessory mounting device 802. While continuing to depress both side buttons, the optical accessory mounting device 802 is placed over the camera 810 such that the optical accessory component is aligned to the camera 810. After the alignment to the camera 810, the side buttons are released and the engagement gap reduces due to the counter-urging force exerted by the counter-urging member, and the optical accessory mounting device 802 effectively clamps onto the top of the mobile device or engages the front and rear surfaces as shown in FIGS. 8C and 8D. The operation is substantially similar for the attachment as shown in FIG. 8B where the camera is provided on a front surface of the mobile device.

FIG. 9 is a schematic flowchart 900 for illustrating a method of mounting an optical accessory mounting device in an example embodiment. At step 902, a first engagement member is movably disposed against a second engagement member. At step 904, a stopper member is provided disposed between the first engagement member and the second engagement member. At step 906, the first engagement member and the second engagement member are urged apart using one or more urging members. At step 908, the optical accessory mounting device is mounted over a desired position. At step 910, the first engagement member and the second engagement member are translationally urged towards each other using a counter-urging member, the counter-urging member being disposed between the stopper member and one of the first engagement member and the second engagement member.

In the described example embodiments, the optical accessory mounting device may overcome problems faced in the prior art. This may be due to the incorporation of the counter-urging member in the optical accessory mounting device. In the described embodiments, depressing side buttons of the optical accessory mounting device enables the engagement gap in between the first and second engagement members to increase before placement on a mobile device. This may effectively reduce likelihood of permanent scratching or damage on the display surface and back housing of the mobile device as well as accidental removal of screen protection films which typically result from the conventional “push-in” adaptors. Additionally, the use of counter-urging member in the optical accessory mounting device may ensure a secure fitting of optical accessories on the mobile device. For example, use of a rod spring mechanism secured by rod screws at both ends of the central rod may ensure such a secure fitting.

Further, in the described example embodiments, the engagement gap is variable and may provide a larger tolerance to different thicknesses and different mobile devices. For devices with different thicknesses, when the side buttons of the optical accessory mounting device are released, the counter-urging member returns to its original position and urges the engagement gap to decrease, thus providing a secure grip on such devices.

Further, usage of the exemplary central rod spring mechanism and exemplary side button spring mechanism may ensure that spring tension are maintained and reduces the likelihood of eventual loose fitting even after repeated removal and attachment, due to the use of spring compression rather than spring extension.

Another advantage of some of the described example embodiments includes the use an external connector to connect the optical accessories to the optical accessory mounting device. The external connector may be made from, but is not limited to, metal. The external connector may employ metal screw threading. Using a metal connector ensures durability of the optical accessory mounting device and strength of the connection between the optical accessories and the optical accessory mounting device.

In addition, since the described example embodiments provide translational movements during the urging apart and urging together of the engagement members, a pivotal/rotational type mechanism such as the clothespin mechanism is avoided. Thus, the example embodiments are more compact in nature and thus reduce the likelihood of being accidentally knocked off after mount. Further, the compact nature may ensure relatively fast and easier mounting compared to magnetic mounts.

Furthermore, in the described example embodiments, the first and second engagement members of the optical accessory mounting device may be urged apart and mounted with the first and second engagement members being substantially parallel. As such, advantageously, optical accessories may be provided flushed and parallel to a camera of a mobile device, and therefore providing better images.

In addition, the optical accessory mounting device may also be made of, but not limited to, plastic material. Therefore, the optical accessory mounting device may be made portable and lightweight. It would be apparent to a person skilled in the art that other examples of lightweight, durable materials may be suitable for manufacturing the present embodiments.

It would also be apparent to a person skilled in the art that many other types of mobile devices besides those illustrated and described herein can be used together with the present disclosure.

The stopper member of the example embodiments may not necessarily be provided integrally with the first engagement member of the optical accessory mounting device. In some embodiments, the stopper member is disposed independently of the first engagement member and the second engagement member. For example, the stopper member may be removably attached to one of the first and second engagement members. In other embodiments, the stopper member is disposed integrally with the second engagement member. Furthermore, the first and the second engagement members may be interchangeable with each other with respect to the counter-urging member.

In example embodiments, the tip of the urging members may be conical in shape or tapering in shape. In one embodiment, the tip may be a conical tip. However, it is appreciated that the example embodiments are not limited as such and may include any tip that has an increasing base diameter and surface area towards the base of the tip in order to physically urge the first and second engagement member apart.

Furthermore, the example embodiments are also not limited to physically urging the first and second engagement member apart and may also include other forms of urging apart. For example, pneumatic transmissions or the like may be used to urge the first and second engagement member apart.

The optical accessory component may comprise any optical device which may work cooperatively with a camera of a mobile device. In some embodiments, the optical accessory component may be an optical lens, a conversion lens, an auxiliary lens, a macro lens, a wide angle lens, a magnifying lens, a lens hood and filters such as a photo filter. The example embodiments may work with any accessory that may be attached to a mounting device, e.g. via screw threads.

In the example embodiments, with a length of a centre extension rod being about 8.2 millimetre (mm), the width/diameter of the rod-like projection of the urging member may be about 2.8 mm leading to the engagement gap being able to vary by about 1 mm. However, it is appreciated that the example embodiments are not limited as such and may include any varying ranges of increase in the engagement gap. For example, the variance of the engagement gap may be 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm or 20 mm.

In addition, even though more than one urging members have been described in the example embodiments, it will be appreciated that the example embodiments are not limited as such. That is, it is possible to use a single urging member (e.g. a side button) to urge the first and second engagement members apart.

In addition, even though screws have been described to primarily fasten the first and second engagement members, it will be appreciated that other types of fastening members may also be used. For example, rivets and bolts may be used.

In the description herein, the terms “coupled” or “connected” as used are intended to cover both directly connected or connected through one or more intermediate means, unless otherwise stated.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

It will be appreciated by a person skilled in the art that other variations and/or modifications may be made to the specific embodiments without departing from the scope of the invention as broadly described. The present embodiments are, therefore, to be considered in all respects to be illustrative and not restrictive.

1. An optical accessory mounting device, the device comprising,
a first engagement member and a second engagement member, the first engagement member being movably disposed against the second engagement member;
one or more urging members capable of urging the first engagement member and the second engagement member apart from each other;
a stopper member disposed between the first engagement member and the second engagement member;
a counter-urging member capable of urging the first engagement member and the second engagement member towards each other; and
wherein the counter-urging member is disposed between the stopper member and one of the first engagement member and the second engagement member to urge the first engagement member and the second engagement member towards each other translationally.

2. The device as claimed in claim 1, further comprising a rod member provided within a channel extending from the first engagement member and the second engagement member, wherein the first engagement member and the second engagement member are movable with respect to each other translationally along the rod member.

3. The device as claimed in claim 2, wherein the counter-urging member is a resilient member provided within a portion of the channel and disposed within the stopper member, wherein the resilient member abuts an internal surface of the stopper member at one end and abuts at another end said one of the first engagement member and the second engagement member.

4. The device as claimed in claim 1, wherein the one or more urging members are configured to move with respect to the first engagement member and the second engagement member to physically urge the first engagement member apart from the second engagement member.

5. The device as claimed in claim 4, wherein the first engagement member and the second engagement member are configured to form one or more housings to house the one or more urging members, wherein the one or more urging members is provided with a decreasing surface area within the one or more housings along the direction of movement of the one or more urging members to physically urge the first engagement member apart from the second engagement member.

6. The device as claimed in claim 5, wherein the one or more housings each comprise a stop wall to limit the movement of the one or more urging members with respect to the first engagement member and the second engagement member.

7. The device as claimed in claim 4, further comprising one or more urging member resilient members, each provided to said one or more urging members for returning the one or more urging members to original positions after a force to urge the first engagement member apart from the second engagement member is removed.

8. The device as claimed in claim 4, wherein the counter-urging member is configured to provide a counter-urging force in a transverse direction to the direction of movement of the one or more urging members.

9. The device as claimed in claim 1, wherein said one of the first engagement member and the second engagement member comprises an aperture.

10. The device as claimed in claim 1, further comprising a fitment member to couple to an external connector for connecting to an optical accessory.

11. A method of mounting an optical accessory mounting device, the method comprising,
movably disposing a first engagement member against a second engagement member;
providing a stopper member disposed between the first engagement member and the second engagement member;
urging the first engagement member and the second engagement member apart using one or more urging members;
mounting the optical accessory mounting device over a desired position;
translationally urging the first engagement member and the second engagement member towards each other using a counter-urging member, the counter-urging member being disposed between the stopper member and one of the first engagement member and the second engagement member.

12. The method as claimed in claim 11, wherein the step of movably disposing a first engagement member against a second engagement member further comprises providing a rod member within a channel extending from the first engagement member and the second engagement member; and
wherein the step of urging the first engagement member and the second engagement member apart using one or more urging members and the step of translationally urging the first engagement member and the second engagement member towards each other using a counter-urging member each comprises moving the first engagement member and the second engagement member with respect to each other translationally along the rod member.

13. The method as claimed in claim 12, wherein the step of providing a counter-urging member to urge the first engagement member towards the second engagement member comprises providing the counter-urging member as a resilient member within a portion of the channel;
disposing the resilient member within the stopper member, wherein the resilient member abuts an internal surface of the stopper member at one end and abuts at another end said one of the first engagement member and the second engagement member.

14. The method as claimed in claim 11, wherein the step of urging the first engagement member apart from the second engagement member using one or more urging members comprises moving the one or more urging members with respect to the first engagement member and the second engagement member to physically urge the first engagement member apart from the second engagement member.

15. The method as claimed in claim 14, further comprising providing the first engagement member and the second engagement member to form one or more housings to house the one or more urging members, wherein the one or more urging members is provided with a decreasing surface area within the one or more housings along the direction of movement of the one or more urging members to physically urge the first engagement member apart from the second engagement member.

16. The method as claimed in claim 15, further comprising limiting the movement of the one or more urging members with respect to the first engagement member and the second engagement member with a stop wall provided within the one or more housings.

17. The method as claimed in claim 14, further comprising providing one or more urging member resilient members, each provided to said one or more urging members; and
returning the one or more urging members to original positions after a force to physically urge the first engagement member apart from the second engagement member is removed.

18. The method as claimed in claim 14, wherein the step of urging the first engagement member towards the second engagement member using a counter-urging member comprises providing a counter-urging force in a transverse direction to the direction of movement of the one or more urging members.

19. The method as claimed in claim 11, coupling an external connector for connecting to an optical accessory to said one of the first engagement member and the second engagement member using a fitment member.
